(19) United States
(12) Patent Application Publication
(10) Pub. No.: US 2006/0242904 A1
(43) Pub. Date: Nov. 2, 2006

(54) Catalyst for producing liquefied petroleum gas, process for producing the same, and process for producing liquefied petroleum gas with the catalyst

(76) Inventors: Kaoru Fujimoto, Kitakyushu-shi (JP); Kenji Asami, Kitakyushu-shi (JP); Sachio Asaoka, Kitakyushu-shi (JP); Xiaohong Li, Kitakyushu-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/546,754

(22) PCT Filed: Feb. 25, 2004
(86) PCT No.: PCT/JP04/02202

§ 371 Date: Jun. 13, 2006

(30) Foreign Application Priority Data
Feb. 26, 2003 (JP) 2003-049588

(51) Int. Cl. B01J 29/04; C10J 3/46

(52) U.S. Cl. 48/197 R; 502/60

(57) ABSTRACT

A catalyst for producing a liquefied petroleum gas of this invention comprises a methanol synthesis catalyst component and a zeolite catalyst component, and a liquefied petroleum gas containing propane as a main component is produced by reacting carbon monoxide with hydrogen in the presence of this catalyst.

### FIELD OF THE INVENTION

This invention relates to a catalyst for producing a liquefied petroleum gas containing propane as a main component by reacting carbon monoxide with hydrogen; a process for producing the catalyst; and a process for producing a liquefied petroleum gas with the catalyst.

### BACKGROUND OF THE INVENTION

Liquefied petroleum gas (LPG) is a liquefied petroleum-based or natural-gas-based hydrocarbon which is gaseous at an ambient temperature under an atmospheric pressure by compression while optionally cooling, and the main component of it is propane or butane. LPG is advantageously transportable because it can be stored or transported in a liquid form. Thus, in contrast with a natural gas that requires a pipeline for supply, it has a characteristic that it can be filled in a container to be supplied to any place. For that reason, LPG comprising propane as a main component, i.e., propane gas has been widely used as a fuel for household and business use. At present, propane gas is supplied to about 25 million households (more than 50% of the total households) in Japan. Propane gas is also used as an industrial fuel and an automobile fuel.

Conventionally, LPG has been produced by 1) collection from a wet natural gas, 2) collection from a stabilization (vapor-pressure regulating) process of crude petroleum, 3) separation and extraction of a product in, for example, a petroleum refining process, or the like.

LPG, in particular propane gas used as a household/business fuel, can be expected to be in great demand in the future. Thus, it may be very useful to establish an industrially practicable and new process for producing LPG.

As a process for producing LPG, “Selective Synthesis of LPG from Synthesis Gas”, Kaoru Fujimoto et al., Bull. Chem. Soc. Jpn., 58, p. 3059-3060 (1985) discloses that, using a hybrid catalyst consisting of a methanol synthesis catalyst such as a 4 wt % Pd/SiO₂, a Cu—Zn—Al mixed oxide {Cu:Zn:Al=40:23:37 (atomic ratio)} or a Cu-based low-pressure methanol synthesis catalyst (Trade name: BASF S3-85) and a high-silica Y-type zeolite with SiO₂/Al₂O₃=7.6, C2 to C4 paraffins can be produced in a selectivity of 69 to 85% via methanol and dimethyl ether from a synthesis gas. However, in the process, the selectivity of propane (C3) and butane (C4) is about 63 to 74%, and the product of the process may not be suitable for LPG products.

Furthermore, butane is the main component of the product obtained by the process described in the above-mentioned “Selective Synthesis of LPG from Synthesis Gas”, Bull. Chem. Soc. Jpn., 58, p. 3059-3060 (1985). As described above, propane gas is the LPG used as a fuel for household and business use. Propane gas has the advantage that it can be continuously combusted with a stably higher power at low temperature in comparison with butane gas. Propane gas is superior to butane gas as a liquefiable fuel gas, which is widely used as a household/business fuel and as an industrial fuel and an automobile fuel, because propane gas has a sufficient, higher vapor pressure in winter or in a cold region and generates higher calories during combustion.

### DISCLOSURE OF THE INVENTION

An objective of this invention is to provide a catalyst capable of producing a liquefied petroleum gas containing propane as a main component by reacting carbon monoxide with hydrogen; a process for producing the catalyst; and a process for producing a liquefied petroleum gas with the catalyst.

The present invention provides a catalyst for producing a liquefied petroleum gas containing propane as a main component by reacting carbon monoxide with hydrogen, comprising a methanol synthesis catalyst component and a zeolite catalyst component.

Moreover, the present invention provides the above catalyst for producing a liquefied petroleum gas, wherein a ratio (by weight) of the methanol synthesis catalyst component to the zeolite catalyst component is 0.5 to 3 (the methanol synthesis catalyst component/the zeolite catalyst component).

Moreover, the present invention provides the above catalyst for producing a liquefied petroleum gas, wherein the zeolite catalyst component is a zeolite with a SiO₂/Al₂O₃ molar ratio of 10 to 50.

Moreover, the present invention provides the above catalyst for producing a liquefied petroleum gas, wherein the zeolite catalyst component is a middle-pore or large-pore zeolite in which pores permitting diffusion of reactant molecules extend three-dimensionally.

Furthermore, the present invention provides a process for producing the above catalyst for producing a liquefied petroleum gas, comprising steps of:

separately preparing the methanol synthesis catalyst component and the zeolite catalyst component; and

mixing them.

Furthermore, the present invention provides a process for producing a liquefied petroleum gas, comprising a step of: reacting carbon monoxide with hydrogen in the presence of the above catalyst for producing a liquefied petroleum gas, whereby producing a liquefied petroleum gas containing propane as a main component.

Moreover, the present invention provides a process for producing a liquefied petroleum gas, comprising a step of: passing a synthesis gas through a catalyst layer comprising the above catalyst for producing a liquefied petroleum gas, whereby producing a liquefied petroleum gas containing propane as a main component.

Moreover, the present invention provides a process for producing a liquefied petroleum gas, comprising steps of:

(1) producing a synthesis gas by reacting a hydrocarbon gas with steam; and

(2) passing the synthesis gas through a catalyst layer comprising the above catalyst for producing a liquefied petroleum gas, whereby producing a liquefied petroleum gas containing propane as a main component.

When reacting carbon monoxide and hydrogen in the presence of the catalyst according to this invention, the following reactions may proceed to give LPG containing propane as a main component. First, on the methanol synthesis catalyst component, methanol is formed from carbon monoxide and hydrogen. Then, methanol thus formed is converted to a lower-olefin hydrocarbon comprising propylene as a main component at an active site in a pore in the zeolite catalyst component. In the reaction, methanol would be dehydrated to give a carbene (H₂C:), which is subjected to polymerization to give a lower olefin. The lower olefin thus generated is released from the pore in the zeolite catalyst component and is rapidly hydrogenated on the methanol synthesis catalyst component to give LPG containing propane as a main component.

In the presence of the catalyst according to this invention, the reaction product is favorable in the methanol synthesis reaction because formed methanol rapidly becomes a raw material of the next reaction (conversion reaction from methanol to a lower-olefin). And, in the conversion reaction of methanol, in addition to the low amount of the raw material, methanol, in the system, the used catalyst is the so-called high-silica type zeolite, preferably, a zeolite with a SiO₂/Al₂O₃ molar ratio of 10 to 50, having active sites in a lower density in which diffusion of reactant molecules is limited. Consequently, a polymerization reaction completes with a lower polymerization degree, giving a lower olefin comprising propylene as a main component. The lower olefin thus produced can be easily released from a pore in the zeolite catalyst component, which is relatively larger and three-dimensionally extends, allowing a reactant molecule to diffuse. Then, the olefin is rapidly hydrogenated on the methanol synthesis catalyst component to become inactivated in further polymerization and thus to be stabilized.

### BRIEF DESCRIPTION OF THE DRAWINGS

FIG. 1 is a process flow diagram showing a main configuration in an example of an LPG producing apparatus suitable for conducting the process for LPG production according to this invention. Description of the Main Symbols:

1: a reformer

1a: a reforming catalyst layer

2: a reactor

2a: a catalyst layer

3, 4, 5: lines.

### BEST MODE FOR CARRYING OUT THE INVENTION

A catalyst according to the present invention comprises a methanol synthesis catalyst component and a zeolite catalyst component. Herein, a “methanol synthesis catalyst component” means a compound which can act as a catalyst in the reaction of CO+2H₂→CH₃OH. And a “zeolite catalyst component” means a zeolite which can act as a catalyst in a condensation reaction of methanol into a hydrocarbon and/or a condensation reaction of dimethyl ether into a hydrocarbon.

A ratio of the methanol synthesis catalyst component to the zeolite catalyst component (by weight) is preferably 0.5 or more (methanol synthesis catalyst component/zeolite catalyst component), more preferably 0.8 or more (methanol synthesis catalyst component/zeolite catalyst component). A ratio of the methanol synthesis catalyst component to the zeolite catalyst component (by weight) is preferably 3 or less (methanol synthesis catalyst component/zeolite catalyst component), more preferably 2 or less (methanol synthesis catalyst component/zeolite catalyst component). By adjusting a ratio of the methanol synthesis catalyst component to the zeolite catalyst component within the above range, propane can be produced with a higher selectivity and a higher yield.

A methanol synthesis catalyst component acts as a methanol synthesis catalyst. And, a zeolite catalyst component acts as a solid acid zeolite catalyst, whose acidity is adjusted, in a condensation reaction of methanol into a hydrocarbon and/or a condensation reaction of dimethyl ether into a hydrocarbon. A ratio of the methanol synthesis catalyst component to the zeolite catalyst component is, therefore, reflected in a relative ratio of the ability to form methanol to the ability to form a hydrocarbon from methanol, which the catalyst of this invention has. In this invention, when reacting carbon monoxide and hydrogen to produce a liquefied petroleum gas comprising propane as a main component, carbon monoxide and hydrogen must be sufficiently converted into methanol by the action of a methanol synthesis catalyst component, and methanol produced must be sufficiently converted, by the action of a zeolite catalyst component, into an olefin comprising propylene as a main component, which must be converted into a liquefied petroleum gas comprising propane as a main component by the action of a methanol synthesis catalyst component.

By adjusting a ratio of the methanol synthesis catalyst component to the zeolite catalyst component (by weight) to 0.5 or more (methanol synthesis catalyst component/zeolite catalyst component), carbon monoxide and hydrogen can be converted into methanol with a higher conversion. Furthermore, by adjusting a ratio of the methanol synthesis catalyst component to the zeolite catalyst component (by weight) to 0.8 or more (methanol synthesis catalyst component/zeolite catalyst component), methanol produced can be converted into a liquefied petroleum gas comprising propane as a main component with a higher selectivity.

On the other hand, by adjusting a ratio of the methanol synthesis catalyst component to the zeolite catalyst component (by weight) to 3 or less (methanol synthesis catalyst component/zeolite catalyst component), more preferably 2 or less (methanol synthesis catalyst component/zeolite catalyst component), methanol produced can be converted into a liquefied petroleum gas comprising propane as a main component with a higher conversion.

Examples of a methanol synthesis catalyst component include known methanol synthesis catalyst; specifically, a Cu—Zn-based catalyst and a catalyst wherein the third component is added thereto, such as a Cu—Zn-based catalyst, a Cu—Zn—Cr-based catalyst, a Cu—Zn—Al-based catalyst, a Cu—Zn—Ag-based catalyst, a Cu—Zn—Mn—V-based catalyst, a Cu—Zn—Mn—Cr-based catalyst and a Cu—Zn—Mn—Al—Cr-based catalyst; a Ni—Zn-based catalyst, a Mo-based catalyst, a Ni—C-based catalyst, and a noble metal-based catalyst such as a Pd-based catalyst. A commercially available methanol synthesis catalyst can be used.

Preferable zeolite catalyst components include a middle-pore or large-pore zeolite in which pores into which reactant molecules can diffuse extend three-dimensionally. Such zeolites include ZSM-5, MCM-22, β- and Y-type zeolites, for example. In this invention, a zeolite wherein reactant molecules three-dimensionally diffuse in pores including a middle-pore zeolite such as ZSM-5 and MCM-22 and a large-pore zeolite such as β- and Y-type zeolites, which generally have high selectivity in a condensation reaction of methanol and/or dimethyl ether into an alkyl-substituted aromatic hydrocarbon, are preferable to a small-pore zeolite such as SAPO-34 and a zeolite wherein reactant molecules do not three-dimensionally diffuse in pores such as mordenite, which generally have high selectivity in a condensation reaction of methanol and/or dimethyl ether into a lower olefin hydrocarbon. By using a zeolite wherein reactant molecules three-dimensionally diffuse in pores including a middle-pore zeolite and a large-pore zeolite, methanol formed may be converted into a lower olefin comprising propylene as a main component, and further into a liquefied petroleum gas comprising propane as a main component with a higher selectivity.

Herein, a middle-pore zeolite means a zeolite with a pore size of 0.44 to 0.65 nm formed mainly by a 10-membered ring. And a large-pore zeolite means a zeolite with a pore size of 0.66 to 0.76 nm formed mainly by a 12-membered ring. A zeolite catalyst component more preferably has a pore size of 0.5 nm or more in view of selectivity for C3 component in the gaseous product. In addition, a zeolite catalyst component more preferably has a skeletal pore size of 0.77 nm or less in view of inhibiting the formation of the liquid product including an aromatic compound such as benzene and a gasoline component such as C5 component.

As a zeolite catalyst component, a so-called high-silica zeolite may be preferable; specifically, a zeolite with a SiO₂/Al₂O₃ molar ratio of 10 to 50. By using a high-silica zeolite with a SiO₂/Al₂O₃ molar ratio of 10 to 50, methanol produced may be converted into an olefin comprising propylene as a main component, and further into a liquefied petroleum gas comprising propane as a main component with a higher selectivity.

A particularly preferable zeolite catalyst component is a middle-pore or large-pore zeolite with a SiO₂/Al₂O₃ molar ratio of 10 to 50 in which pores permitting diffusion of reactant molecules extend three-dimensionally. Such zeolites include a solid acid zeolite such as USY zeolite and high-silica-type β-zeolite, for examole.

The above solid acid zeolite, whose acidity is adjusted by ion-exchanging and the like, is used as a zeolite catalyst component.

Next, there will be described a process for producing the catalyst according to this invention.

A catalyst according to this invention is preferably produced by separately preparing a methanol synthesis catalyst component and a zeolite catalyst component, and then mixing them. By separately preparing a methanol synthesis catalyst component and a zeolite catalyst component, a composition, a structure and a property of each component can be easily optimized for each function. Generally, a methanol synthesis catalyst requires to be basic, while a zeolite catalyst requires to be acidic. Thus, optimization for each function may be difficult when both catalyst components are prepared all together.

A methanol synthesis catalyst component can be prepared by a known method, and a commercially available methanol synthesis catalyst can be used. Some of methanol synthesis catalysts must be activated by reduction treatment before use. In this invention, it is not necessarily required to activate a methanol synthesis catalyst component by reduction treatment in advance. The methanol synthesis catalyst component can be activated by reduction treatment of the catalyst of this invention, before the beginning of the reaction, after producing the catalyst by mixing a methanol synthesis catalyst component and a zeolite catalyst component, and then molding the mixture.

A zeolite catalyst component can be prepared by a known method, and a commercially available zeolite can be used. A zeolite catalyst component can be, if necessary, subjected to acid property adjustment by, for example, metal-ion-exchange, before mixing with a methanol synthesis catalyst component.

A catalyst according to the present invention may be produced by homogeneously mixing a methanol synthesis catalyst component and a zeolite catalyst component, and then molding the mixture. A procedure of mixing and molding these catalyst components is not particularly limited, but is preferably a dry method. When mixing and molding these catalyst components by a wet method, there may occur a compound transfer between these catalyst components, for example, neutralization due to transfer of a basic component in a methanol synthesis catalyst component to an acidic site in a zeolite catalyst component, leading to the change of a property optimized for each function of these catalyst components, and the like.

A catalyst according to the present invention may comprise other additive components as long as its intended effect would not be impaired, as necessary.

Next, there will be described a process for producing a liquefied petroleum gas, preferably comprising propane as a main component, by reacting carbon monoxide and hydrogen using a catalyst according to this invention as described above.

A reaction temperature is preferably 270° C. or higher, more preferably 300° C. or higher, in the light of further sufficiently high activity of both a methanol synthesis catalyst component and a zeolite catalyst component. On the other hand, a reaction temperature is preferably 400° C. or lower, more preferably 380° C. or lower, in the light of the restrictive temperature for the use of the catalyst, restriction on the equilibrium and easy removal or recovery of the reaction heat.

A reaction pressure is preferably 1 MPa or higher, more preferably 2 MPa or higher, in the light of further sufficiently high activity of a methanol synthesis catalyst component. On the other hand, a reaction pressure is preferably 10 MPa or lower, more preferably 5 MPa or lower, in the light of economical efficiency.

A gas space velocity is preferably 500 hr⁻¹ or more, more preferably 2000 hr⁻¹ or more, in the light of economical efficiency. In addition, a gas space velocity is preferably 10000 hr⁻¹ or less, more preferably 5000 hr⁻¹ or less, in order that each of a methanol synthesis catalyst component and a zeolite catalyst component may give a contact time achieving a further sufficient conversion.

A concentration of carbon monoxide in a gas fed into a reactor is preferably 20 mol % or more, more preferably 25 mol % or more, in the light of ensuring a pressure (partial pressure) of carbon monoxide required for the reaction, and improving a specific productivity of the materials. In addition, a concentration of carbon monoxide in a gas fed into a reactor is preferably 40 mol % or less, more preferably 35 mol % or less, in the light of a further sufficiently high conversion of carbon monoxide.

A concentration of hydrogen in a gas fed into a reactor is preferably 1.5 moles or more, more preferably 1.8 moles or more per one mole of carbon monoxide, in order that carbon monoxide may react more sufficiently. In addition, a concentration of hydrogen in a gas fed into a reactor is preferably 3 moles or less, more preferably 2.3 moles or less per one mole of carbon monoxide, in the light of economical efficiency.

A gas fed into a reactor may contain carbon dioxide in addition to carbon monoxide and hydrogen which are raw materials. By recycling carbon dioxide discharged from the reactor, or by adding the corresponding amount of carbon dioxide, formation of carbon dioxide from carbon monoxide by a shift reaction in the reactor can be substantially reduced or be eliminated.

A gas fed into a reactor can contain water vapor. And a gas fed into a reactor can contain an inert gas, and the like.

A gas fed into a reactor can be dividedly fed to the reactor so as to control a reaction temperature.

The reaction can be conducted in a fixed bed, a fluidized bed, a moving bed or the like, and can be preferably selected, taking both of control of a reaction temperature and a regeneration method of the catalyst into account. For example, a fixed bed may include a quench type reactor such as an internal multistage quench type, a multitubular type reactor, a multistage type reactor having a plurality of internal heat exchangers or the like, a multistage cooling radial flow type, a double pipe heat exchange type, an internal cooling coil type, a mixed flow type, and other types of reactors.

When used, a catalyst according to the present invention can be diluted with silica, alumina or an inert and stable heat conductor for controlling a temperature. In addition, when used, a catalyst according to the present invention can be applied to the surface of a heat exchanger for controlling a temperature.

In this invention, a synthesis gas can be used as a raw material gas. A synthesis gas may be produced by a known method; for example, reaction of a hydrocarbon gas such as a natural gas (methane) with steam.

In a steam reforming of a natural gas, for example, the natural gas is devulcanized through an activated carbon, and then mixed with steam or a mixture of steam and carbon dioxide. The resulting gas is passed through a tubular reactor filled with a nickel-based catalyst at 850 to 890° C. and 1.5 to 2 MPa to give a synthesis gas. As a reforming catalyst, in addition to a nickel-based catalyst, a Rh-based catalyst, a Ru-based catalyst or the like can be used. For obtaining a synthesis gas having a suitable composition as a raw material gas in this invention, a natural gas is reformed preferably using a nickel/alumina solid solution catalyst, fused zirconia, or magnesia-supported Rh or Ru catalyst, at an economically advantageous low steam/carbon ratio, specifically a steam/carbon ratio of about 0.8 to 1.2.

A synthesis gas can be also produced by reacting a hydrocarbon gas such as a natural gas with carbon dioxide, or by reacting a hydrocarbon gas such as a natural gas with oxygen.

After producing a synthesis gas by, for example, steam reforming of a natural gas, a composition of the synthesis gas can be adjusted by a shift reaction (CO+H₂O→CO_{2 l +H}₂) to make a raw material gas.

In the process for producing LPG according to this invention, a water gas produced from a coal coke can be also used as a raw material gas.

Next, there will be described an embodiment of a process for producing LPG according to this invention with reference to the drawing.

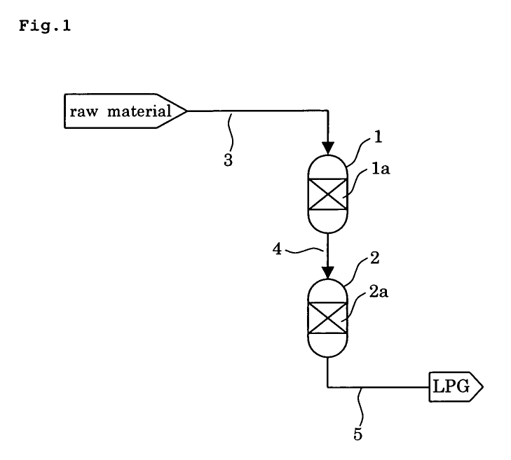

FIG. 1 shows an embodiment of an LPG production apparatus suitable for carrying out a production process for LPG according to this invention.

First, a natural gas (methane) as a reaction raw material is fed into a reformer 1 via a line 3. And, for steam reforming, steam (not shown) is also fed into the line 3. In the reformer 1, there is a reforming catalyst layer la comprising a reforming catalyst. The reformer 1 also has a heating means for supplying heat required for reforming (not shown). In the reformer 1, methane is reformed in the presence of the reforming catalyst to produce a synthesis gas containing hydrogen and carbon monoxide.

The synthesis gas thus produced is fed into a reactor 2 via a line 4. In the reactor 2, there is a catalyst layer 2a comprising a catalyst of this invention. In the reactor 2, a hydrocarbon gas containing propane as a main component is produced from the synthesis gas in the presence of the catalyst of this invention.

The hydrocarbon gas thus produced is pressurized and cooled, after optional removal of water or the like, and LPG, which is a product, is obtained from a line 5. Optionally, hydrogen and the like may be removed from the LPG by, for example, gas-liquid separation.

The LPG production apparatus may be, as necessary, provided with a booster, a heat exchanger, a valve, an instrumentation controller and so on, which are not shown.

Alternatively, a gas obtained by adding carbon dioxide or the like to the synthesis gas produced in the reformer 1 may be fed into the reactor 2. And, a gas obtained by adding additional hydrogen or carbon monoxide to the synthesis gas produced in the reformer 1, or a gas obtained by adjusting its composition by a shift reaction, may be fed into the reactor 2.

According to the process for LPG production of this invention, LPG containing propane as a main component; specifically, LPG with a content of propane of 38 mol % or more, specifically 40 mol % or more, more specifically 55 mol % or more (including 100 mol %) can be produced. LPG produced according to the present invention has a composition suitable for a propane gas, which is widely used as a fuel for household and business use.

### EXAMPLES

The following will describe the present invention in more detail with reference to Examples. However, the present invention is not limited to these Examples.

### Example 1

(Preparation of a Catalyst)

A mechanically powdered commercially available Cu—Zn-based methanol synthesis catalyst (produced by Süd Chemie Japan, Inc.) was used as a methanol synthesis catalyst component. A separately prepared proton-type USY zeolite (skeletal pore size: 0.74 nm) powder with a SiO₂/Al₂O₃ molar ratio of 12.2 was used as a zeolite catalyst component.

The methanol synthesis catalyst component and the zeolite catalyst component of equal weight were homogeneously mixed. And, the mixture was pressure-formed, sized and then reduced under a hydrogen stream at 300° C. for 3 hours to give a catalyst.

(Production of LPG)

The catalyst thus prepared was placed into a tubular reactor, and a raw material gas having a composition of 66.7 mol % of hydrogen and 33.3 mol % of carbon monoxide was passed through the catalyst. The reaction conditions were as follows; the reaction temperature: 325° C.; the reaction pressure: 2.1 MPa; and the gas space velocity: 3000 hr⁻¹. Gas chromatographic analysis of the product indicated that a conversion of carbon monoxide to hydrocarbons was 38%. The produced hydrocarbon gas contained 76% of propane and butane on the basis of carbon, which consisted of 55% of propane and 45% of butane on the basis of carbon.

### Example 2

(Preparation of a Catalyst)

A catalyst was prepared in the same way as Example 1, except that a separately prepared proton-type β-zeolite (pore size: minor axis: 0.64 nm and major axis: 0.76 nm) powder with a SiO₂/Al₂O₃ molar ratio of 37.1 was used as a zeolite catalyst component.

(Production of LPG)

Using the prepared catalyst, the reaction was conducted in the same way as Example 1. As a result, a conversion of carbon monoxide to hydrocarbons was 32%. The produced hydrocarbon gas contained 73% of propane and butane on the basis of carbon, which consisted of 51% of propane and 49% of butane on the basis of carbon.

### Example 3

(Preparation of a Catalyst)

A catalyst was prepared in the same way as Example 1, except that a separately prepared proton-type mordenite zeolite (pore size: minor axis: 0.65 nm and major axis: 0.70 nm) powder with a SiO₂/Al₂O₃ molar ratio of 16.9 was used as a zeolite catalyst component.

(Production of LPG)

Using the prepared catalyst, the reaction was conducted in the same way as Example 1. As a result, a conversion of carbon monoxide to hydrocarbons was 5%. The produced hydrocarbon gas contained 40% of propane and butane on the basis of carbon, which consisted of 28% of propane and 72% of butane on the basis of carbon.

### Example 4

(Preparation of a Catalyst)

A catalyst was prepared in the same way as Example 1, except that a separately prepared proton-type ZSM-5 zeolite (pore size: minor axis: 0.53 nm and major axis: 0.56 nm) powder with a SiO₂/Al₂O₃ molar ratio of 14.5 was used as a zeolite catalyst component.

(Production of LPG)

Using the prepared catalyst, the reaction was conducted in the same way as Example 1, except that carbon dioxide was added to the raw material gas at a molar ratio of 0.08. As a result, a conversion of carbon monoxide to hydrocarbons was 40%. The produced hydrocarbon gas contained 56% of propane and butane on the basis of carbon, which consisted of 56% of propane and 44% of butane on the basis of carbon.

### Example 5

(Preparation of a Catalyst)

A catalyst was prepared in the same way as Example 1, except that a separately prepared proton-type ZSM-5 zeolite (pore size: minor axis: 0.53 nm and major axis: 0.56 nm) powder with a SiO₂/Al₂O₃ molar ratio of 54.5 was used as a zeolite catalyst component.

(Production of LPG)

Using the prepared catalyst, the reaction was conducted in the same way as Example 4. As a result, a conversion of carbon monoxide to hydrocarbons was 3%. The produced hydrocarbon gas contained 7% of propane and butane on the basis of carbon, which consisted of 100% of propane and 0% of butane on the basis of carbon.

### INDUSTRIAL APPLICABILITY

As described above, by using the catalyst of this invention, a liquefied petroleum gas containing propane as a main component can be produced by reacting carbon monoxide and hydrogen.

1. A catalyst for producing a liquefied petroleum gas containing propane as a main component by reacting carbon monoxide with hydrogen, comprising a methanol synthesis catalyst component and a zeolite catalyst component.

2. The catalyst for producing a liquefied petroleum gas according to claim 1, wherein a ratio (by weight) of the methanol synthesis catalyst component to the zeolite catalyst component is in the range between 0.5 and 3 (the methanol synthesis catalyst component/the zeolite catalyst component).

3. The catalyst for producing a liquefied petroleum gas according to claim 1, wherein the zeolite catalyst component is a zeolite with a SiO₂/Al₂O₃ molar ratio in the range between 10 and 50.

4. The catalyst for producing a liquefied petroleum gas according to claim 1, wherein the zeolite catalyst component is a middle-pore or large-pore zeolite in which pores permitting diffusion of reactant molecules extend three-dimensionally.

5. A process for producing the catalyst for producing a liquefied petroleum gas according to claim 1, comprising steps of:
separately preparing the methanol synthesis catalyst component and the zeolite catalyst component; and
mixing them.

6. A process for producing a liquefied petroleum gas, comprising a step of: reacting carbon monoxide with hydrogen in the presence of the catalyst for producing a liquefied petroleum gas according to claim 1, whereby producing a liquefied petroleum gas containing propane as a main component.

7. A process for producing a liquefied petroleum gas, comprising a step of: passing a synthesis gas through a catalyst layer comprising the catalyst for producing a liquefied petroleum gas according to claim 1, whereby producing a liquefied petroleum gas containing propane as a main component.

8. A process for producing a liquefied petroleum gas, comprising steps of:
(1) producing a synthesis gas by reacting a hydrocarbon gas with steam; and
(2) passing the synthesis gas through a catalyst layer comprising the catalyst for producing a liquefied petroleum gas according to claim 1, whereby producing a liquefied petroleum gas containing propane as a main component.

9. The process for producing a liquefied petroleum gas according to claim 6, wherein the content of propane in the liquefied petroleum gas produced is 38 mol % or more.

10. The process for producing a liquefied petroleum gas according to claim 7, wherein the content of propane in the liquefied petroleum gas produced is 38 mol % or more.

11. The process for producing a liquefied petroleum gas according to claim 8, wherein the content of propane in the liquefied petroleum gas produced is 38 mol % or more.
